(19) United States
(12) Patent Application Publication
(10) Pub. No.: US 2021/0245112 A1
(43) Pub. Date: Aug. 12, 2021

(54) MIXED MATRIX MEMBRANES, AND RELATED GAS SEPARATION MEMBRANE APPARATUSES, GASEOUS FLUID TREATMENT SYSTEMS, AND METHODS

(71) Applicants: Battelle Energy Alliance, LLC, Idaho Falls, ID (US); UChicago Argonne, LLC, Chicago, IL (US); Adamas Nanotechnologies, Inc., Raleigh, NC (US)

(72) Inventors: Frederick F. Stewart, Idaho Falls, ID (US); Christopher J. Orme, Firth, ID (US); John R. Klaehn, Idaho Falls, ID (US); Birendra Adhikari, Ammon, ID (US); Olga Aleksandrovna Shenderova, Raleigh, NC (US); Nicholas Austin Nunn, Garner, NC (US); Marco D. Torelli, Raleigh, NC (US); Gary Elder McGuire, Chapel Hill, NC (US); Tae H. Lee, Naperville, IL (US); Uthamalingam Balachandran, Willowbrook, IL (US)

(21) Appl. No.: 17/174,796

(22) Filed: Feb. 12, 2021

Related U.S. Application Data
(60) Provisional application No. 62/975,328, filed on Feb. 12, 2020.

(51) Int. Cl. B01D 69/14; B01D 53/22; B01D 67/00; B01D 71/02; B01D 71/68; B01D 71/38; B01D 71/82

(52) U.S. Cl. CPC B01D 69/148; B01D 2317/025; B01D 67/0079; B01D 71/021; B01D 71/68; B01D 71/38; B01D 71/82; B01D 2256/12; B01D 2257/102; B01D 2323/36; B01D 2325/12; B01D 2325/20; B01D 2325/22; B01D 2325/24; B01D 53/228

(57) ABSTRACT

A mixed matrix membrane comprises a support structure. The support structure comprises a glassy polymer matrix, and nanodiamond particles dispersed within the glassy polymer matrix. A gas separation membrane apparatus, a gaseous fluid treatment system, and a method of forming a mixed matrix membrane are also described.

### CROSS-REFERENCE TO RELATED APPLICATION

This application claims the benefit under 35 U.S.C. § 119(e) of U.S. Provisional Patent Application Ser. No. 62/975,328, filed Feb. 12, 2020, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05ID14517 awarded by the United States Department of Energy. The government has certain rights in the invention.

### TECHNICAL FIELD

The disclosure, in various embodiments, relates to mixed matrix membranes, and to related gas separation membrane apparatuses, gaseous fluid treatment systems, and methods.

### BACKGROUND

Combustion and gasification processes are more generally efficient and productive when using gaseous fluids enriched in oxygen relative to air. However, conventional methods of producing oxygen-enriched fluids, such as cryogenic distillation and pressure swing absorption, are better suited to large scale base load and are generally cost prohibitive for use in modular systems that are more suitable to transient conditions.

### BRIEF SUMMARY

Embodiments described herein include mixed matrix membranes, and related gas separation membrane apparatuses, gaseous fluid treatment systems, and methods. In accordance with one embodiment described herein, a mixed matrix membrane comprises a support structure. The support structure comprises a glassy polymer matrix, and nanodiamond particles dispersed within the glassy polymer matrix.

In additional embodiments, a method of forming a mixed matrix membrane comprises forming a support structure comprising a glassy polymer matrix and nanodiamond particles dispersed within the glassy polymer matrix.

In further embodiments, gas separation membrane apparatus comprises a housing structure, and a mixed matrix membrane contained within the housing structure. The mixed matrix membrane comprises a support structure, and a selective structure coupled to the support structure. The support structure comprises a glassy polymer matrix, and nanodiamond particles dispersed within the glassy polymer matrix. The selective structure comprises at least one material selectively permeable to oxygen gas.

In still further embodiments, gaseous fluid treatment system comprises a gaseous fluid source, and at least one gas separation membrane apparatus downstream of the gaseous fluid source. The gaseous fluid source is configured to produce a gaseous fluid stream comprising oxygen gas and one or more other materials. The at least one gas separation membrane apparatus comprises a housing structure, and a mixed matrix membrane positioned between a first region and a second region of an internal chamber of the housing structure. The mixed matrix membrane comprises a glassy polymer matrix comprising polysulfone, and functionalized nanodiamond particles dispersed within the glassy polymer matrix.

### BRIEF DESCRIPTION OF THE DRAWINGS

FIG. 1 is a simplified cross-sectional view of a mixed matrix membrane, in accordance with embodiments of the disclosure.

FIG. 2 is a simplified transverse cross-sectional view of a gas separation membrane apparatus, in accordance with embodiments of the disclosure.

FIG. 3 is a simplified transverse cross-sectional view of a gas separation membrane apparatus, in accordance with additional embodiments of the disclosure.

FIG. 4 is a simplified schematic view of a gaseous fluid treatment system, in accordance with embodiments of the disclosure.

FIG. 5 is a graphical representation of the O₂ permeability analysis results described in Example 1.

FIGS. 6 and 7 are graphical representations of the O₂ permeability analysis results described in Example 2.

FIG. 8 is a graphical representation of the O₂ permeability, N₂ permeability, and O₂/N₂ selectivity analysis results described in Example 3.

FIG. 9 is a scanning electron microscopy (SEM) image showing the microstructure evaluation results described in Example 5.

FIGS. 10 through 13 are SEM images showing the microstructure evaluation results described in Example 6.

FIGS. 14 through 16 are SEM images showing the microstructure evaluation results described in Example 7.

FIG. 17 is a graphical representation of the thermal gravimetric analysis (TGA) results described in Example 8.

FIG. 18 is a graphical representation of the thermomechanical analysis results described in Example 9.

FIGS. 19 through 22 are graphical representations of the isothermal stress-strain analysis results described in Example 10.

### DETAILED DESCRIPTION

The following description provides specific details, such as material compositions and processing conditions (e.g., temperatures, pressures, flow rates, etc.) in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the present disclosure are described in detail below. A person of ordinary skill in the art will understand that some process components (e.g., pipelines, line filters, valves, temperature detectors, flow detectors, pressure detectors, and the like) are inherently disclosed herein and that adding various conventional process components and acts would be in accord with the disclosure. In addition, the drawings accompanying the application are for illustrative purposes only, and are not meant to be actual views of any particular material, device, or system.

As used herein, the terms “comprising,” “including,” “having,” and grammatical equivalents thereof are inclusive or open-ended terms that do not exclude additional, unrecited elements or method steps, but also include the more restrictive terms “consisting of” and “consisting essentially of” and grammatical equivalents thereof. As used herein, the term “may” with respect to a material, structure, feature, or method act indicates that such is contemplated for use in implementation of an embodiment of the disclosure and such term is used in preference to the more restrictive term “is” so as to avoid any implication that other, compatible materials, structures, features, and methods usable in combination therewith should or must be excluded.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped, etc.) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “configured” refers to a size, shape, material composition, material distribution, orientation, and arrangement of one or more of at least one structure and at least one apparatus facilitating operation of one or more of the structure and the apparatus in a pre-determined way.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “compatible” means that a material does not undesirably react, decompose, or absorb another material, and also that the material does not undesirably impair the chemical and/or mechanical properties of the another material.

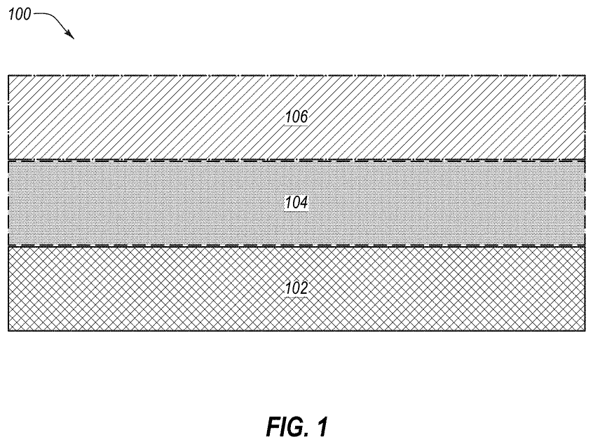

FIG. 1 is a simplified, partial cross-sectional view of a mixed matrix membrane 100, in accordance with embodiments of the disclosure. As shown in FIG. 1, the mixed matrix membrane 100 includes a support structure 102. Optionally, the mixed matrix membrane 100 may further include a selective structure 104 on or over the support structure 102. In addition, if the selective structure 104 is present, the mixed matrix membrane 100 may, optionally, further include a gutter structure 106 in physical contact with the selective structure 104. If present, the gutter structure 106 may overlie the selective structure 104, such that the selective structure 104 is interposed between the support structure 102 and the gutter structure 106; or the gutter structure 106 may underlie the selective structure 104, such that the gutter structure 106 is interposed between the support structure 102 and the selective structure 104. As described in further detail below, the mixed matrix membrane 100 may be used to separate at least one gas (e.g., oxygen (O₂) gas) from at least one other material (e.g., another gas, such as nitrogen (N₂) gas; entrained solid particles; etc.).

The support structure 102 of the mixed matrix membrane 100 may include a glassy polymer matrix, and nanodiamond particles dispersed within the glassy polymer matrix. The support structure 102 is configured to be permeable to at least one gas. Optionally, the mixed matrix membrane 100 may further include one or more other additives dispersed within the glassy polymer matrix, such as one or more additives that enhance or facilitate transport (e.g., mitigation) of the at least one gas through the mixed matrix membrane 100. The support structure 102 may also be configured to be compatible with and to support the selective structure 104 (if any) thereon or thereover, as described in further detail below.

The glassy polymer matrix of the support structure 102 may be formed of and include at least one glassy polymer. As used herein, a “glassy polymer” means and includes an amorphous polymer, a semicrystalline polymer, or a crystalline polymer having a glass transition temperature (T_{g}) above room temperature. Glassy polymers are different than rubbery polymers. As used herein, a “rubbery polymer” means and includes an amorphous polymer or a semicrystalline polymer having a T_{g} below room temperature. As used herein, a “semicrystalline polymer” means and includes a polymer with crystalline domains and amorphous domains and having a T_{g} above room temperature or below room temperature. By way of non-limiting example, glassy polymer matrix may be formed of and include one or more of polysulfone (PSF), polyphenylene oxide (PPO), a polyimide (PI), and polyamide (PA). In some embodiments, the glassy polymer matrix of the support structure 102 is formed of and includes PSF.

The glassy polymer matrix of the support structure 102 may be formed of and include a single (e.g., only one) glassy polymer, or may be formed of and include a blend of at least two different glassy polymers. In some embodiments, the glassy polymer matrix is formed of and includes only one glassy polymer. For example, the glassy polymer matrix may only include PSF. In additional embodiments, the glassy polymer matrix is formed of and includes a blend of two of more glassy polymers. For example, the glassy polymer matrix may include a blend of PSF and PPO.

The nanodiamond particles of the support structure 102 may be formed of and include diamond material. The diamond material may comprise one or more of natural diamond and synthetic diamond. Each of the nanodiamond particles may individually be substantially homogeneous, such that a material composition and a material distribution of the nanodiamond particle is substantially uniform (e.g., non-variable) throughout all regions thereof; or one or more (e.g., each) of the nanodiamond particles may individually be heterogeneous, such that a material composition and/or a material distribution of the nanodiamond particle is substantially non-uniform (e.g., variable) throughout two or more different regions thereof. In some embodiments, at least some (e.g., each) of the nanodiamond particles are individually heterogeneous. For example, at least some of the nanodiamond particles may individually comprise a core of diamond (sp³ carbon) at least partially (e.g., substantially) surrounded by at least one shell comprising another carbon material (e.g., one or more of diamond-like carbon (DLC), sp²/sp³ hybridized carbon, and sp² carbon).

At least some (e.g., each) of the nanodiamond particles of the support structure 102 may be functionalized. For example, at least some of the nanodiamond particles may include functional groups providing the nanodiamond particles desirable dispersion characteristics (e.g., within solvent employed to form the support structure 102; within a glassy polymer) and/or desirable material affinities (e.g., O₂ affinities) or aversions. Non-limiting examples of functional groups that may be attached to the nanodiamond particles include carboxylic acid groups (COOH), carboxylates with alkyl groups including from one (1) carbon atom to twenty (20) carbon atoms (e.g., three (3) carbon atoms (C₃), six (6) carbon atoms (C₆), twelve (12) carbon atoms (C₁₂), eighteen (18) carbon atoms (C₁₈)), and perfluoro groups (e.g., —CF₂H groups, —OCH₂CF₂CF₂H groups). In some embodiments, at least some of nanodiamond particles comprise carboxylic acid surface functionalized nanodiamond (COOH-ND) particles. In additional embodiments, at least some of the nanodiamond particles comprise C₁₈ alkyl ester group functionalized nanodiamond (C₁₈-ND) particles.

Each of the nanodiamond particles may individually exhibit a desired particle size, such as a particle size within a range of from about 2 nanometers (nm) to about 8 nm, such as within a range of from about 4 nm to about 6 nm, or from about 4 nm about 5 nm. In some embodiments, each of the nanodiamond particles individually has a particle size within a range of from about 4 nm to about 6 nm. In addition, each of the nanodiamond particles may individually exhibit a desired shape, such as at least one of a spherical shape, a hexahedral shape, an ellipsoidal shape, a cylindrical shape, a tubular shape, a conical shape, or an irregular shape. In some embodiments, each of the nanodiamond particles individually exhibits a generally spherical shape.

Some of the nanodiamond particles may be clustered (e.g., aggregated) together within the glassy polymer matrix of the support structure 102. The clusters of the nanodiamond particles may individually have a size within a range of from about 10 nm to about 500 nm. The sizes of the clusters of the nanodiamond particles may at least partially depend on the functionalization of the nanodiamond particles. As a non-limiting example, COOH-ND particles may be grouped together in clusters individually having a size within a range of from about 20 nm to about 50 nm (e.g., from about 30 nm to about 50 nm). As another non-limiting example, C₁₈-ND particles may be grouped together in clusters individually having a size within a range of from about 80 nm to about 200 nm (e.g., from about 80 nm to about 150 nm, from about 100 nm to about 130 nm). The clusters of the nanodiamond particles may impart regions of the support structure 102 including the clusters with microporosity at least partially defined by interstitial spaces between nanodiamond particles of a cluster, as described in further detail below.

The nanodiamond particles of the support structure 102 may be monodisperse, wherein each of the nanodiamond particles has substantially the same size, shape, material composition, and material distribution as each other of the nanodiamond particles; or may be polydisperse, wherein the nanodiamond particles include a range of sizes, shapes, material compositions, and/or material distributions. In some embodiments, the nanodiamond particles are substantially monodisperse. In additional embodiments, the nanodiamond particles are substantially polydisperse.

The nanodiamond particles may be distributed throughout an entirety of the support structure 102. In addition, amounts of the nanodiamond particles within different regions of the support structure 102 may be substantially uniform (e.g., substantially consistent, substantially non-variable). In additional embodiments, the nanodiamond particles may be distributed throughout less than an entirety of the support structure 102, and/or amounts of the nanodiamond particles within two or more different regions of the support structure 102 may be non-uniform (e.g., inconsistent, variable).

The support structure 102 may include from about 1 weight percent (wt %) nanodiamond particles to about 25 wt % nanodiamond particles. The amount of nanodiamond particles included within the support structure 102 may at least partially depend on the properties (e.g., material composition) of the glassy polymer matrix of the support structure 102, and on the functionalization(s) of the nanodiamond particles. In some embodiments wherein the glassy polymer matrix of the support structure 102 comprises PSF, the support structure 102 comprises from about 1 wt % COOH-ND particles to about 10 wt % COOH-ND particles (e.g., from about 1 wt % COOH-ND particles to about 6 wt % COOH-ND particles, from about 2 wt % COOH-ND particles to about 5 wt % COOH-ND). In some additional embodiments wherein the glassy polymer matrix of the support structure 102 comprises PSF, the support structure 102 comprises from about 1 wt % C₁₈-ND particles to about 20 wt % C₁₈-ND particles (e.g., from about 1 wt % C₁₈-ND particles to about 16 wt % C₁₈-ND particles, from about 2 wt % C₁₈-ND particles to about 16 wt % C₁₈-ND particles, from about 5 wt % C₁₈-ND particles to about 16 wt % C₁₈-ND particles).

As previously discussed, optionally, the support structure 102 may further include one or more additional materials (e.g., other additives) dispersed within the glassy polymer matrix thereof. By way of non-limiting example, the support structure 102 may include at least one additional material that enhances selective transport of one or more gases (e.g., O₂ gas) through the mixed matrix membrane 100. The additional material may, for example, comprise a metal complex able to reversibly bind to O₂ and encourage permeation though a hopping mechanism wherein O₂ physically moves from and between metal centers. The metal complex may have affinity to O₂ over other materials (e.g., N₂) of a gaseous fluid to be treated by the mixed matrix membrane 100. As a non-limiting, the support structure 102 may further include cobalt(II) phthalocyanine (Co-PC) dispersed within the glassy polymer matrix thereof. The nanodiamond particles of the support structure 102 may promote or facilitate desirable distribution of the one or more additional materials (if any) throughout the support structure 102.

The support structure 102 may exhibit porosity at least partially dependent on the process employed to form the support structure 102. In some embodiments, such as embodiments wherein the support structure 102 is not formed through a phase inversion process (described in further detail below), the support structure 102 includes microporous regions and substantially non-porous regions. As used herein, a feature (e.g., structure, material, region) that is “microporous” includes pores or cavities with diameters less than about 2 nm. The microporous regions of the support structure 102 may, for example, comprise regions including clusters of the nanodiamond particles. Pores of individual microporous regions may be defined by interstitial spaces between nanodiamond particles of a cluster of the nanodiamond particles. The non-porous regions of the support structure 102 may, for example, comprise regions including dispersed, non-clustered nanodiamond particles, and/or regions free of nanodiamond particles (e.g., regions only including the glassy polymer matrix). In additional embodiments, such as embodiments wherein the support structure 102 is formed through a phase inversion process (described in further detail below), the support structure 102 may exhibit relatively large pores extending through. The pores may, for example, have diameters greater than 2 nm, such as within a range of from about 50 nm to about 500 nm, or from about 100 nm to about 250 nm.

In some embodiments, the support structure 102 is formed without the use of phase inversion processing acts. For example, at least one glassy polymer (e.g., PSF), nanodiamond particles (e.g., functionalized nanodiamond particles, such as COOH-ND particles, C₁₈-ND particles, etc.), at least one solvent (e.g., a casting solvent), and, optionally, one or more additives (e.g., O₂ transport enhancers, such as Co-PC), may be combined to form a mixture. The solvent employed in the process may comprise a liquid that is able to dissolve the glassy polymer and suspend the nanodiamond particles. The solvent may also be selected to have a relatively low boiling point, such as a boiling point less than or equal to about 70° C. By way of non-limiting example, the solvent may comprise one or more of tetrahydrofuran (THF) and chloroform. The mixture may be substantially homogeneous as formed. Following formation, the mixture may be deposited (e.g., cast) on or over another structure (e.g., a mold structure) to form a coating on or over the mold structure. The solvent may be volatilized and substantially removed from the coating to form the support structure 102. For example, the coating may be heated to a temperature above the boiling point of the solvent for a sufficient time to boil off and substantially remove the solvent. In such embodiments, the support structure 102 may comprise a thin, relatively dense film including regions of microporosity imparted by clusters of the nanodiamond particles.

In additional embodiments, the support structure 102 is formed with the use of phase inversion processing acts. For example, at least one glassy polymer (e.g., PSF), nanodiamond particles (e.g., functionalized nanodiamond particles, such as COOH-ND particles, C₁₈-ND particles, etc.), at least one solvent (e.g., a casting solvent), and, optionally, one or more additives (e.g., O₂ transport enhancers, such as Co-PC), may be combined to form a mixture. The mixture may be substantially homogeneous as formed. The solvent employed in the process may comprise a liquid that is able to dissolve the glassy polymer and suspend the nanodiamond particles, and that is also miscible in another solvent (e.g., water) employed for the phase inversion processing acts. The solvent may be less volatile (e.g., have a relatively higher boiling point) than the solvent employed to form the support structure 102 without the use of phase inversion processing acts. By way of non-limiting example, the solvent may comprise one or more of N-methylpyrrolidone (NMP), N,N-dimethylacetamide (DMAc), N,N-dimethylformamide (DMF) and dimethylsulfoxide (DMSO). The mixture may be substantially homogeneous as formed. Following formation, the mixture may be deposited (e.g., cast) on or over another structure (e.g., a mold structure) to form a coating on or over the mold structure. The coating may than be subjected to a phase inversion process to form the support structure 102. The phase inversion process may include treating the coating with the additional solvent (e.g., water) to dissolve and remove the solvent from the coating. In such embodiments, the support structure 102 may comprise a relatively porous film including pores extending through the glassy polymer matrix thereof, wherein the pores are formed through the removal of the solvent during the phase inversion process.

With continued reference to FIG. 1, if present, the selective structure 104 of the mixed matrix membrane 100 may comprise at least one material providing selectivity to at least one gas (e.g., O₂ gas) over at least one other gas (e.g., N₂ gas). The selective structure 104 (if any) may be selectively permeable to the at least one gas relative to the at least one other gas. In some embodiments, the selective structure 104 is formed of and includes at least one glassy polymer, such as one or more of PSF, PPO, PI, and PA. The glassy polymer of the selective structure 104 (if any) may be substantially the same as the glassy polymer of the support structure 102, or the glassy polymer of the selective structure 104 (if any) may be different than the glassy polymer of the support structure 102. In some embodiments, the selective structure 104 comprises one or more of PSF and PPO. If present, the selective structure 104 may, optionally, further include one or more of nanodiamond particles (e.g., functionalized nanodiamond particles, such as nanodiamond particles include one or more of carboxylate groups, alkyl ester groups, and perfluoro groups attached thereto) and other additives (e.g., materials enhancing or facilitating O₂ transport) dispersed therethrough (e.g., distributed within the glassy polymer thereof). The nanodiamond particles (if any) and other additives (if any) may be substantially similar to or may be different than the nanodiamond particles and the other additives (if any) of the support structure 102 of the mixed matrix membrane 100. In some embodiments, the selective structure 104 includes functionalized nanodiamond particles (e.g., COOH-ND particles, C₁₈-ND particles) dispersed throughout a glassy polymer matrix. An amount of functionalized nanodiamond particles included in the selective structure 104 may be substantially the same as (e.g., substantially equal to) an amount of functionalized nanodiamond particles included in the support structure 102; or an amount of functionalized nanodiamond particles included in the selective structure 104 may be different than (e.g., less than, or greater than) an amount of functionalized nanodiamond particles included in the support structure 102. In some embodiments, an amount of functionalized nanodiamond particles included in the selective structure 104 is less than an amount of functionalized nanodiamond particles included in the support structure 102.

If present, the selective structure 104 may be formed with or without the use of phase inversion processing acts. The selective structure 104 may, for example, be formed through a process substantially similar to one of the processes previously described herein with respect to the formation of the support structure 102 of the mixed matrix membrane 100.

Still referring to FIG. 1, if present, the gutter structure 106 of the mixed matrix membrane 100 may comprise at least one material that effectively serves to resolve (e.g., mitigate, patch) defects (if any) within the selective structure 104. The gutter structure 106 (if any) may be selectively permeable to at least one gas (e.g., O₂ gas) over at least one other gas (e.g., N₂ gas). In some embodiments, the selective structure 104 is formed of and includes at least one polymer, such as polydimethylsiloxane (PDMS). If present, the gutter structure 106 may, optionally, further include one or more of nanodiamond particles (e.g., functionalized nanodiamond particles, such as nanodiamond particles include one or more of carboxylate groups, alkyl groups, and perfluoro groups attached thereto) and other additives (e.g., materials enhancing or facilitating O₂ transport) dispersed therethrough (e.g., distributed within the polymer thereof). The nanodiamond particles (if any) and other additives (if any) may be substantially similar to or may be different than the nanodiamond particles and the other additives (if any) of the support structure 102 of the mixed matrix membrane 100. In some embodiments, the gutter structure 106 includes functionalized nanodiamond particles (e.g., COOH-ND particles, C₁₈-ND particles) dispersed throughout PDMS. An amount of functionalized nanodiamond particles included in the gutter structure 106 may be substantially the same as (e.g., substantially equal to) an amount of functionalized nanodiamond particles included in the support structure 102; or an amount of functionalized nanodiamond particles included in the gutter structure 106 may be different than (e.g., less than, or greater than) an amount of functionalized nanodiamond particles included in the support structure 102. In some embodiments, an amount of functionalized nanodiamond particles included in the gutter structure 106 is less than an amount of functionalized nanodiamond particles included in the support structure 102.

If present, the gutter structure 106 may be formed in physical contact with the selective structure 104 through a process substantially similar to one of the processes (e.g., the process without phase inversion processing acts) previously described herein with respect to the formation of the support structure 102 of the mixed matrix membrane 100.

In some embodiments, the mixed matrix membrane 100 is formed to include the support structure 102 and the selective structure 104, and is formed to be selectively permeable to O₂ gas over N₂ gas. The mixed matrix membrane 100 may, for example, be formed to have an O₂ permeability greater than or equal to about 10 Barrers (e.g., greater than or equal to about 50 Barrers, greater than or equal to about 100 Barrers, greater than or equal to about 200 Barrers, greater than or equal to about 300 Barrers, greater than or equal to about 400 Barrers, greater than or equal to about 500 Barrers, or within a range of from about 10 Barrers to about 500 Barrers), and to have a selectivity to O₂ over N₂ greater than 1 (e.g., greater than or equal to about 1.5, greater than or equal to about 2, greater than or equal to about 3, greater than or equal to about 5, or greater than or equal to about 6).

The mixed matrix membrane 100, including the components thereof (e.g., the support structure 102, the selective structure 104 (if any), the gutter structure 106 (if any)), may be formed to exhibit any desired dimensions and any shape facilitating selective migration of one or more gases (e.g., O₂ gas) therethrough during use within a predetermined gas membrane separation apparatus. By way of non-limiting example, the mixed matrix membrane 100 may be formed to exhibit one or more of a cubic shape, cuboidal shape, a tubular shape, a tubular spiral shape, a spherical shape, a semi-spherical shape, a cylindrical shape, a semi-cylindrical shape, a conical shape, a triangular prismatic shape, a truncated version of one or more of the foregoing, and an irregular shape. In some embodiments, the mixed matrix membrane 100 is formed to exhibit a substantially flat sheet shape (e.g., a plate shape). The mixed matrix membrane 100 may, for example, be configured for a plate and frame design. In additional embodiments, the mixed matrix membrane 100 is formed to exhibit a different shape, such as a hollow fiber shape, a tubular shape (e.g., a linear tubular shape; a non-linear tubular shape, such an angled tubular shape, a curved tubular shape), or a spiraled shape (e.g., a spiral wound shape). A spiraled shape of the mixed matrix membrane 100 may, for example, comprise one or more (e.g., multiple) structures (e.g., layered structures, stacked structures) wound around a separate, tubular structure.

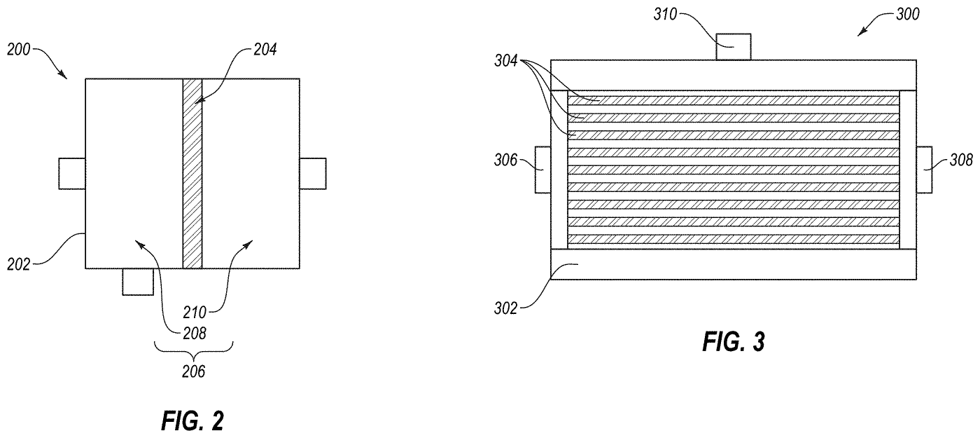

Mixed matrix membranes (e.g., the mixed matrix membrane 100) in accordance with embodiments of the disclosure may be used in embodiments of gas separation membrane apparatuses of the disclosure. For example, FIG. 2 is a simplified transverse cross-sectional view of a gas separation membrane apparatus 200, in accordance with embodiments of disclosure. As shown in FIG. 2, the gas separation membrane apparatus 200 includes at least one housing structure 202 and at least one mixed matrix membrane 204 within the housing structure 202. The mixed matrix membrane 204 may be substantially similar to and may be formed in substantially the same manner as the mixed matrix membrane 100 previously described with reference to FIG. 1. As described in further detail below, the gas separation membrane apparatus 200 may be configured and operated to selectively remove one or more gases (e.g., O₂ gas) of at least one gaseous feed fluid from one or more other material(s) (e.g., other gases, such as N₂ gas; entrained particles; etc.) of the gaseous feed fluid.

The housing structure 202 of the gas separation membrane apparatus 200 may exhibit any shape (e.g., a tubular shape, a quadrilateral shape, a spherical shape, a semi-spherical shape, a cylindrical shape, a semi-cylindrical shape, truncated versions thereof, or an irregular shape) and size able to contain (e.g., hold) the mixed matrix membrane 204 therein, to direct a gaseous feed stream to a first side of the mixed matrix membrane 204, and to direct a gaseous product stream and a feed remnants stream away from the gas separation membrane apparatus 200. The housing structure 202 may be formed of and include any material (e.g., glass, metal, alloy, polymer, ceramic, composite, combinations thereof, etc.) compatible with the operating conditions (e.g., temperatures, pressures, material interactions) of the gas separation membrane apparatus 200.

As shown in FIG. 2, the housing structure 202 of the gas separation membrane apparatus 200 may at least partially define at least one (e.g., one, more than one) internal chamber 206 (e.g., internal open volume, internal cavity) at least partially (e.g., substantially) surrounding the mixed matrix membrane 204. The mixed matrix membrane 204 may serve as a boundary between at least one (e.g., one, more than one) first region 208 (e.g., at least one gaseous feed fluid region, at least one gaseous feed fluid channel) of the internal chamber 206 configured and positioned to receive gaseous feed fluid and to direct feed fluid remnants from the gas separation membrane apparatus 200, and at least one (e.g., one, more than one) second region 210 (e.g., at least one permeate region, at least one permeate channel) of the internal chamber 206 configured and positioned to direct produced gaseous fluid from the gas separation membrane apparatus 200.

The mixed matrix membrane 204 may be coupled to or integral with the housing structure 202. Optionally, at least one additional structure may be configured and positioned to support (e.g., maintain the position of) the mixed matrix membrane 204 within the housing structure 202. The mixed matrix membrane 204 may exhibit any desired position and any desired orientation within the housing structure 202. By way of non-limiting example, as shown in FIG. 2, the mixed matrix membrane 204 may be positioned centrally about and extend parallel to a central axis of the housing structure 202. In additional embodiments, the mixed matrix membrane 204 may exhibit one or more of a different position and a different orientation within the housing structure 202. By way of non-limiting example, the mixed matrix membrane 204 may be positioned more distal from (e.g., offset from) the central axis of the housing structure 202, and/or may extend non-parallel (e.g., perpendicular to, diagonal to, etc.) to the central axis of the housing structure 202.

The mixed matrix membrane 204 may exhibit any dimensions and any shape facilitating selective migration of one or more material(s) (e.g., of a gaseous feed fluid) within the first region 208 of the internal chamber 206 of the gas separation membrane apparatus 200 into the second region 210 of the internal chamber 206 of the gas separation membrane apparatus 200. The dimensions and the shape of the mixed matrix membrane 204 may be selected relative to the dimensions and the shape of the housing structure 202 such that the mixed matrix membrane 204 is substantially contained within boundaries of the housing structure 202, and such that the mixed matrix membrane 204 at least partially (e.g., substantially) intervenes between different regions (e.g., the first region 208 and the second region 210) of the internal chamber 206 of the gas separation membrane apparatus 200. By way of non-limiting example, the mixed matrix membrane 204 may at least partially (e.g., substantially) extend (e.g., horizontally extend, vertically extend) between opposing surfaces (e.g., horizontal surfaces, vertical surfaces) of the housing structure 202, and may exhibit one or more of a cubic shape, cuboidal shape, a tubular shape, a tubular spiral shape, a spherical shape, a semi-spherical shape, a cylindrical shape, a semi-cylindrical shape, a conical shape, a triangular prismatic shape, a truncated version of one or more of the foregoing, and irregular shape. As shown in FIG. 2, in some embodiments, the mixed matrix membrane 204 exhibits a substantially flat sheet shape extending from a first end of the housing structure 202 to a second, opposing end of the housing structure 202. In such embodiments, the first region 208 of the internal chamber 206 of the mixed matrix membrane 204 may be positioned adjacent a first external surface of the mixed matrix membrane 204, and the second region 210 of the internal chamber 206 of the mixed matrix membrane 204 may be positioned adjacent a second, opposing external surface of the mixed matrix membrane 204, or vice versa.

With continued reference to FIG. 2, although the gas separation membrane apparatus 200 is depicted in FIG. 2 as including a single (i.e., only one) mixed matrix membrane 204, the gas separation membrane apparatus 200 may include any quantity (e.g., number) of mixed matrix membranes 204. Put another way, the gas separation membrane apparatus 200 may include a single (e.g., only one) mixed matrix membrane 204, or may include multiple (e.g., more than one) mixed matrix membranes 204. If the gas separation membrane apparatus 200 includes multiple mixed matrix membranes 204, each of the mixed matrix membranes 204 may be substantially the same (e.g., exhibit substantially the same components, component sizes, component shapes, component material compositions, component material distributions, component positions, component orientations, etc.) and may be operated under substantially the same conditions (e.g., substantially the same temperatures, pressures, flow rates), or at least one of the mixed matrix membranes 204 may be different (e.g., exhibit one or more of different components, different component sizes, different component shapes, different component material compositions, different component material distributions, different component positions, different component orientations) than at least one other of the mixed matrix membranes 204 and/or may be operated under different conditions (e.g., different temperatures, different pressures, different flow rates, etc.) than at least one other of the mixed matrix membranes 204. In some embodiments, two or more mixed matrix membranes 204 are provided in parallel with one another within the housing structure 202 of the gas separation membrane apparatus 200. In additional embodiments, two or more mixed matrix membranes 204 are provided in series with one another within the housing structure 202 of the gas separation membrane apparatus 200.

While FIG. 2 depicts a particular configuration of the gas separation membrane apparatus 200, the gas separation membrane apparatus 200 may exhibit a different configuration, such as a configuration exhibiting one or more of a different size, a different shape, different features, different feature spacing, different components, and a different arrangement of components. FIG. 2 illustrates just one non-limiting example of the gas separation membrane apparatus 200. The gas separation membrane apparatus 200 may, for example, include a different configuration of one or more of the mixed matrix membrane 204 and the housing structure 202, and/or a different arrangement of the mixed matrix membrane 204 and the housing structure 202. By way of non-limiting example, in additional embodiments, the gas separation membrane apparatus 200 exhibits the configuration illustrated in FIG. 3.

As shown in FIG. 3, a gas separation membrane apparatus 300 may include a housing structure 302 and tubular mixed matrix membranes 304 (e.g., hollow fiber membranes; linear tubular membranes; non-linear tubular membranes, such as angled tubular membranes, curved tubular membranes, spiraled tubular membranes; etc.) contained within the housing structure 302. The tubular mixed matrix membranes 304 may be substantially similar to and may be formed in substantially the same manner as the mixed matrix membrane 100 previously describe with reference to FIG. 1. The housing structure 302 and the tubular mixed matrix membranes 304 may have configurations (e.g., sizes, shapes, material compositions, material distributions, positions, orientations, etc.) facilitating the selective separation of one or more gases (e.g., O₂ gas) of at least one gaseous feed fluid from one or more other material(s) (e.g., other gases, such as N₂ gas; entrained particles; etc.) of the gaseous feed fluid. The configurations of the housing structure 302 and the tubular mixed matrix membranes 304 may be selected relative to one another, and in accordance with the considerations previously described with respect to configurations of the housing structure 202 (FIG. 2) and the mixed matrix membrane 204 (FIG. 2).

As shown in FIG. 3, in some embodiments, the gas separation membrane apparatus 300 is configured to receive at least one gaseous feed fluid within at least one feed inlet 306 in the housing structure 302 and direct the gaseous feed fluid into interiors (e.g., hollow interiors) of the tubular mixed matrix membranes 304. One or more gases (e.g., O₂ gas) of the gaseous feed fluid may then be separated from one or more other materials (e.g., other gases, such as N₂ gas; entrained particles; etc.) of the gaseous feed fluid through selective permeation of the one or more gases through the tubular mixed matrix membranes 304. The remnants (e.g., N₂ gas; entrained particles; etc.) of the gaseous feed fluid may then be directed out of the interiors of the tubular mixed matrix membranes 304 and at least one remnants outlet 308 in the housing structure 302, and may be utilized or disposed of as desired. In addition, separated gas(es) (e.g., O₂ gas) may be directed out of at least one product outlet 310 in the housing structure 302, and may also be utilized or disposed of as desired. In additional embodiments, the gaseous feed fluid may be directed around exteriors of the tubular mixed matrix membranes 304, such that the one or more gases (e.g., O₂ gas) of the gaseous feed fluid selectively inwardly permeate through the tubular mixed matrix membranes 304 and into to the interiors (e.g., hollow interiors) thereof. The separated gas(es) (e.g., O₂ gas) may be then directed out of interiors of the tubular mixed matrix membranes 304 and an outlet in the housing structure in fluid communication with the interiors of the tubular mixed matrix membranes 304, and may be utilized or disposed of as desired.

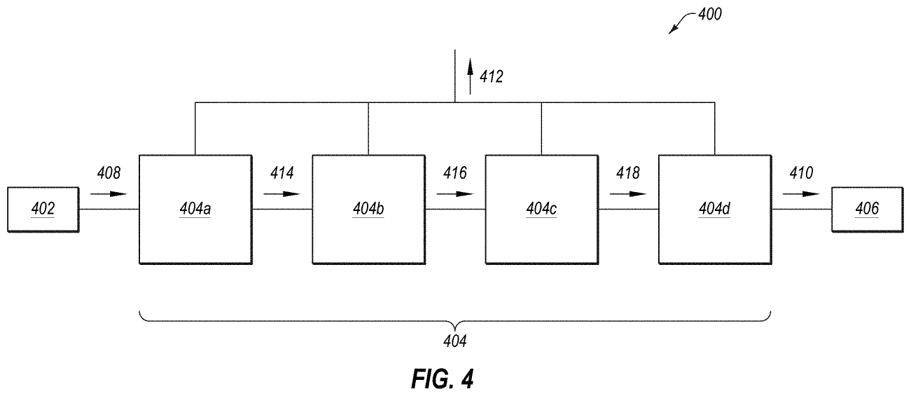

Gas separation membrane apparatuses (e.g., the gas separation membrane apparatuses 200, 300) in accordance with embodiments of the disclosure may be used in embodiments of gaseous fluid treatment systems of the disclosure. For example, FIG. 4 is a simplified schematic view of a gaseous fluid treatment system 400, in accordance with embodiments of disclosure. The gaseous fluid treatment system 400 may be used to separate one or more gas(es) of a gaseous feed fluid from one or more other material(s) (e.g., other gas(es), entrained solid particles) of the gaseous feed fluid.

As shown in FIG. 4, the gaseous fluid treatment system 400 may include at least one gaseous feed source 402, and one or more gas separation membrane apparatuses 404 in fluid communication with (e.g., downstream of) the gaseous feed source 402. One or more (e.g., each) of the gas separation membrane apparatus(es) 404 may be substantially similar to one or more of the gas separation membrane apparatuses 200, 300 previously described with reference to FIGS. 2 and 3. The gas separation membrane apparatus(es) 404 may be configured and operated to receive at least one gaseous feed stream 408 from the gaseous feed source 402 and to selectively separate one or more gases (e.g., O₂ gas) of the gaseous feed stream 408 from one or more other materials (e.g., other gases, such as N₂ gas; entrained particles; etc.) of the gaseous feed stream 408 to form at least one gaseous product stream 410 and at least one feed remnants stream 412. The gaseous product stream 410 may include the separated gas(es) (e.g., O₂ gas) of the gaseous feed stream 408. The feed remnants stream 412 includes remaining material(s) of the gaseous feed stream 408. The gaseous fluid treatment system 400 may further include one or more additional components (e.g., one or more additional apparatuses, such as pumps, flow meters, flow valves, heat exchangers, etc.) facilitating desired flow and/or treatment of one or more of the streams (e.g., the gaseous feed stream 408, the gaseous product stream 410, the feed remnants stream 412, other streams) produced by and/or acted upon by the gaseous fluid treatment system 400.

The gaseous feed source 402 comprises at least one apparatus configured and operated to store and/or produce one or more gaseous fluids. As a non-limiting example, the gaseous feed source 402 may comprise a storage vessel (e.g., a tank) configured and operated to contain a gaseous fluid.

The gaseous feed stream 408 may comprise a gaseous fluid steam including one or more of at least one aqueous gas, at least one organic gas, and at least one non-aqueous, inorganic gas. In some embodiments, the gaseous feed stream 408 comprises O₂ gas and N₂ gas. The gaseous feed stream 408 may exhibit a single (e.g., only one) phase state (e.g., only a gaseous phase), or may exhibit multiple (e.g., more than one) phase states (e.g., a gaseous phase, and a solid phase comprising solid particles entrained in the gaseous phase).

A single (e.g., only one) gaseous feed stream 408 may exit the gaseous feed source 402, or multiple (e.g., more than one) gaseous feed stream 408 may exit the gaseous feed source 402. If multiple gaseous feed stream 408 exit the gaseous feed source 402, each of the gaseous feed streams 408 may exhibit substantially the same properties (e.g., substantially the same material composition, substantially the same temperature, substantially the same pressure, substantially the same flow rate, etc.), or at least one of the multiple gaseous feed streams 408 may exhibit one or more different properties (e.g., a different material composition, a different temperature; a different pressure; a different flow rate) than at least one other of the multiple gaseous feed streams 408.

The gaseous fluid treatment system 400 may include a single (i.e., only one) gas separation membrane apparatus 404, or may include multiple (i.e., more than one) gas separation membrane apparatuses 404. As show in FIG. 4, in some embodiments, the gaseous fluid treatment system 400 includes multiple gas separation membrane apparatuses 404. For example, the gaseous fluid treatment system 400 may include a first gas separation membrane apparatus 404a downstream of the gaseous feed source 402, a second gas separation membrane apparatus 404b downstream of the first gas separation membrane apparatus 404a, a third gas separation membrane apparatus 404c downstream of the second gas separation membrane apparatus 404b, and a fourth gas separation membrane apparatus 404d downstream of the third gas separation membrane apparatus 404c.

If the gaseous fluid treatment system 400 includes multiple gas separation membrane apparatuses 404, each of the gas separation membrane apparatuses 404 may be substantially the same (e.g., may exhibit substantially the same components, component sizes, component shapes, component material compositions, component material distributions, component positions, component orientations, etc.) and may be operated under substantially the same conditions (e.g., substantially the same temperatures, pressures, flow rates, etc.), or at least one of the gas separation membrane apparatuses 404 may be different (e.g., may exhibit one or more of different components, different component sizes, different component shapes, different component material compositions, different component material distributions, different component positions, different component orientations, etc.) than at least one other of the gas separation membrane apparatuses 404 and/or may be operated under different conditions (e.g., different temperatures, different pressures, different flow rates) than at least one other of the gas separation membrane apparatuses 404. As a non-limiting example, the mixed matrix membrane (e.g., corresponding to the mixed matrix membrane 100 previously described with reference to FIG. 1) of the first gas separation membrane apparatus 404a may only include a support structure (e.g., corresponding to the support structure 102 previously described with reference to FIG. 1); and the mixed matrix membrane of one or more (e.g., each) of the other gas separation membrane apparatuses 404b, 404c, 404d may include a support structure (e.g., corresponding to the support structure 102 previously described with reference to FIG. 1) and a selective structure (e.g., corresponding to the selective structure 104 previously described with reference to FIG. 1). The first gas separation membrane apparatus 404a may, for example, be employed to separate gases of the gaseous feed stream 408 from solids (e.g., entrained solid particles) of the gaseous feed stream 408, and the other gas separation membrane apparatuses 404b, 404c, 404d may be employed to separate or further separate one or more desired gases (e.g., O₂ gas) of the gaseous feed stream 408 from one or more other gases (e.g., N₂ gas) of the gaseous feed stream 408.

As shown in FIG. 4, if the gaseous fluid treatment system 400 includes multiple gas separation membrane apparatuses 404, at least some of the gas separation membrane apparatuses 404 may be provided in series with one another. Gas separation membrane apparatuses 404 downstream of other gas separation membrane apparatuses 404 may receive and act upon (e.g., separate gases of) gaseous permeate streams produced by the other gas separation membrane apparatuses 404. For example, the second gas separation membrane apparatus 404b may receive and act upon a first gaseous permeate stream 414 produced by the first gas separation membrane apparatus 404a, the third gas separation membrane apparatus 404c may receive and act upon a second gaseous permeate stream 416 produced by the second gas separation membrane apparatus 404b, and the fourth gas separation membrane apparatus 404d may receive and act upon a third gaseous permeate stream 418 produced by of the third gas separation membrane apparatus 404c to produce the gaseous product stream 410. The multiple gas separation membrane apparatuses 404 may work in conjunction with one another to enhance a concentration of a desired gas (e.g., O₂ gas) of the gaseous feed stream 408 in the gaseous product stream 410. In some embodiments, multiple gas separation membrane apparatuses 404 of gaseous fluid treatment system 400 together effectuate the production of a gaseous product stream 410 comprising greater than or equal to about 90 wt % O₂ gas (e.g., greater than or equal to 95 wt % O₂ gas).

With continued reference to FIG. 4, the feed remnants stream(s) 412 formed from and depleted in material(s) (e.g., O₂ gas) relative to the gaseous feed stream 408 may exit the gas separation membrane apparatus(es) 404, and may be utilized or disposed of as desired. In addition, the gaseous product stream 410 exiting the gas separation membrane apparatuses 404 may also be utilized or disposed of as desired. In some embodiments, the gaseous product stream 410 is directed into at least one additional apparatus 406. The configuration(s) and function(s) of the additional apparatus 406 may at least partially depend on the properties (e.g., material composition) of the gaseous product stream 410. As a non-limiting example, if the gaseous product stream 410 is rich in O₂ gas, the additional apparatus 406 may comprise a combustion apparatus configured and operated to receive and combust at least a portion of the gaseous product stream 410.

The membranes (e.g., the mixed matrix membrane 100), apparatuses (e.g., the gas separation membrane apparatuses 200, 300), systems (e.g., the gaseous fluid treatment system 400), and methods of the disclosure facilitate simple and efficient treatment of a gaseous fluid (e.g., the gaseous feed stream 408) to selectivity separate one or more gases (e.g., O₂ gas) of the gaseous fluid from one or more other materials (e.g., other gases, such as N₂ gas; entrained solid particles; etc.) of the gaseous fluid. The membranes, apparatuses, systems, and methods of the disclosure reduce one or more of the time, costs, and energy required to treat the gaseous fluid as compared to conventional membranes, conventional apparatuses, conventional systems, and conventional methods. Accordingly, the membranes, apparatuses, systems, and methods of the disclosure may be more efficient (e.g., increasing material separation efficiency; reducing equipment, material, and/or energy requirements; etc.), durable, and reliable than conventional membranes, conventional apparatuses, conventional systems, and conventional methods for treating a gaseous fluid to selectivity separate one or more gases of the gaseous fluid from one or more other material(s) of the gaseous fluid.

The following examples serve to explain embodiments of the disclosure in more detail. These examples are not to be construed as being exhaustive, exclusive, or otherwise limiting as to the scope of the disclosure.

### EXAMPLES

### Example 1: O₂ Permeability of PSF Loaded with 2 wt % COOH-ND

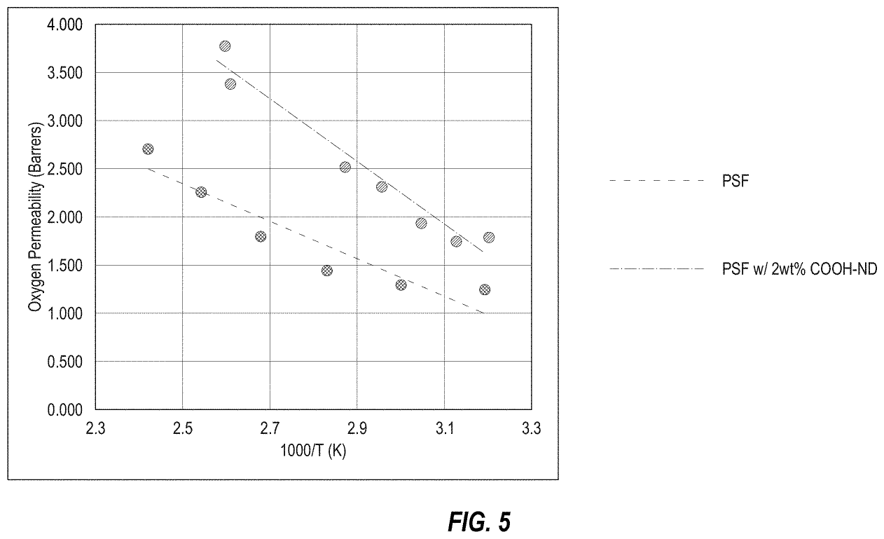

O₂ permeability as a function of temperature was analyzed for PSF loaded with 2 wt % COOH-ND relative to substantially pure PSF. The PSF loaded with 2 wt % COOH-ND was formed to be substantially free of the solvent employed to produce the PSF loaded with 2 wt % COOH-ND. FIG. 5 is a graphical representation of the results of the analysis. As shown in FIG. 5, the O₂ permeability of the PSF loaded with 2 wt % COOH-ND was greater than the O₂ permeability of the substantially pure PSF across all temperatures evaluated.

### Example 2: O₂ Permeability of PSF Loaded with C₁₈-ND and Processed at Different Temperatures

The impact of processing temperature on O₂ permeability was analyzed for PSF loaded with C₁₈-ND.

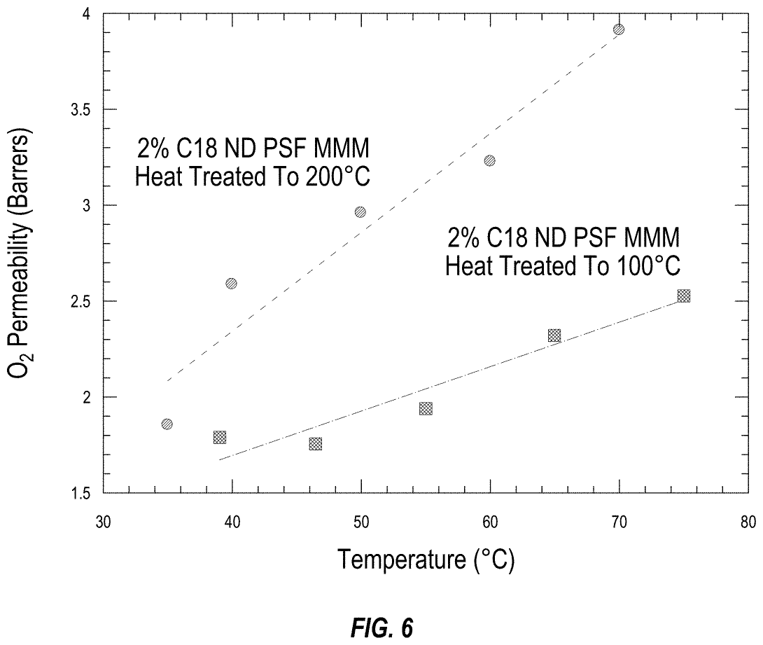

First, the impact of processing temperature on O₂ permeability for mixed matrix membranes including PSF loaded with 2 wt % C₁₈-ND was analyzed. Each mixed matrix membrane was formed using tetrahydrofuran (THF) as a casting solvent. A first of the mixed matrix membranes was thermally processed (e.g., heated) to 100° C., and a second of the mixed matrix membranes was thermally processed to 200° C. The rationale for these temperatures was tied to the use of THF as the casting solvent. THF has a boiling point of 66° C., so 100° C. should theoretically be sufficient to remove it effectively. However, thermogravimetric analysis (TGA) has data indicated that THF may remain in the mixed matrix membrane up to 5% by weight. The higher temperature, 200° C., was chosen since it is higher than the glass transition temperature (T_{g}) for PSF, which is about 188° C. FIG. 6 is a graphical representation of the results of the analysis. As shown in FIG. 6, a substantial increase in permeability was observed in the second mixed matric membrane thermally processed at 200° C. as compared to the first mixed matric membrane processed at 100° C. Without being bound to a particular theory, this data could be interpreted in a differing ways. First, heating to a temperature above the T_{g} for PSF as compared to heating to a temperature below the T_{g} for PSF may impart differing structures. Heating to 200° C. should re-order or anneal the polymer chains to some degree; however, such annealing would be expected to reduce permeability, not increase it. Second, if it is assumed that the resulting polymer morphology is not significantly different between the two processing methods, the difference and permeability may be due to casting solvent. Residual solvent is thought to reside in interstitial spaces needed for gas transport. Removal of such solvent should provide more “channels” through which gases can pass, thus increasing gas flux. Regardless, thermal processing appears to enhance O₂ permeability in mixed matrix membranes including PSF loaded with 2 wt % C₁₈-ND.

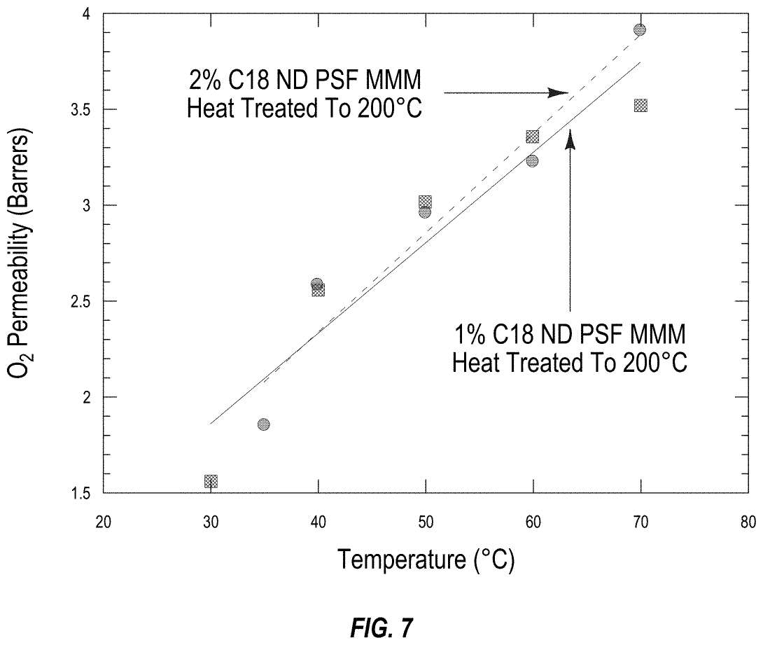

Second, the impact of processing temperature on O₂ permeability for additional mixed matrix membranes including PSF loaded with different weight percentages of C₁₈-ND was analyzed. Each of the additional mixed matrix membranes was formed using THF as a casting solvent. A first of the additional mixed matrix membranes included PSF loaded with 1 wt % C₁₈-ND. A second of the additional mixed matrix membranes included PSF loaded with 2 wt % C₁₈-ND. The first mixed matrix membrane and the second mixed matrix membrane were both thermally processed to 200° C. FIG. 7 is a graphical representation of the results of the analysis. As shown in FIG. 7, the linear regressions were substantially similar, suggesting that heating to 200° C. effectuated similar enhancements in O₂ permeability for PSF loaded with 1 wt % C₁₈-ND and PSF loaded with 2 wt % C₁₈-ND.

### Example 3: Permeability and Selectivity of PSF Loaded with C₁₈-ND

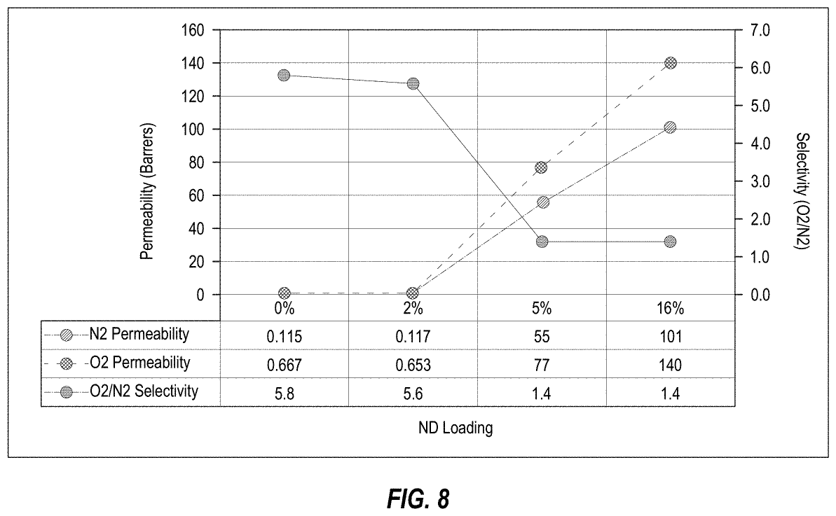

O₂ permeability, N₂ permeability, and O₂/N₂ selectivity of PSF loaded with different amounts (0 wt %, 2 wt %, 5 wt %, and 16 wt %) was analyzed. FIG. 8 is a graphical representation of the results of the analysis. As shown in FIG. 8, at PSF loaded with 5 wt % C₁₈-ND exhibited a 120-fold increase in O₂ permeability relative to the O₂ permeability of substantially pure (0 wt % C₁₈-ND) PSF and was still selective (about 1.4) to O₂ over N₂. In addition, increasing C₁₈-ND loading to 16 wt % resulted in O₂ permeability and N₂ permeability increasing by a factor of 2 relative to PSF loaded with 5 wt % C₁₈-ND. The PSF loaded with 16 wt % C₁₈-ND exhibited O₂ selectivity substantially similar to PSF loaded with 5 wt % C₁₈-ND (i.e., about 1.4). The results indicate that microporosity imparted by the C₁₈-NDs may promote O₂ transport through PSF.

### Example 4: O₂ Permeance and O₂/N₂ Selectivity of Phase Inverted PSF Loaded with C₁₈-ND

O₂ permeance and O₂/N₂ selectivity were analyzed for phase inverted PSF with and without C₁₈-ND. The difference between “permeance” and “permeability” is noted. The approximation used in the analysis is that 1 Barrer is roughly equal to 10 Gas Permeation Units (GPU). “Permeance” is measured in GPU, where membrane thickness is unknown or inconsistent. This contrasts with “permeability,” expressed in Barrers, where membrane thickness is substantially constant and known. Permeability for materials with known thickness, such as thin dense film PSF, can be measured precisely. However, phase inverted materials are porous, allowing for more gas transport. However, many materials including PSF, when phase inverted, can form dense “skin” layers that have different gas transport magnitudes. The inability to measure the homogeneity and thickness of these dense layers make the GPU a practical unit to express gas transport. The results of the analysis are shown in TABLE 1 below.

TABLE 1

| Phase Inverted Membranes | O₂ Permeance | O₂/N₂ |
|---|---|---|
| (PSF Cast From NMP) | (GPU) | Selectivity |
| No C₁₈-ND | 52054 | 0.91 |
| 2 wt % 5 nm C₁₈-ND (no heat) | 48802 | 0.91 |
| 2 wt % nm C₁₈-ND (heated at | 57007 | 1.09 |
| 100° C. for 10 min) | | |

As shown in TABLE 1, phase inverted PSF with no C₁₈-ND content was found to give relatively high permeance, 52,000 GPU, and an O₂/N₂ selectivity of 0.91, which indicates that the material is reverse selective, favoring N₂. Addition of 2 wt % 5 nm C₁₈-ND resulted in a slight drop of permeance to 48,000 GPU, with maintained reverse selectivity. In addition, phase inverted PSF loaded with 2 wt % 5 nm C₁₈-ND and heated in an oven at 100° C. for 10 minutes yielded an improvement in O₂ permeance, 57,000 GPU, and positive O₂ selectivity (1.09). Without being bound to a particular theory, this improvement in O₂ selectivity may be the result of thermal annealing that impacted the porous structure or the dense skin layer. Regardless of the selectivity of these porous materials, reproducible porosity was demonstrated. For the O₂/N₂ gas pair, due to their similar molecular radii (O₂=3.46 Angstroms (Å), N₂=3.64 Å), trade-off (a common principle in membrane science that describes the relationship between permeability and selectivity) is a significant consideration. It is desirable for porous layers to serve as supports for selective layers. Thus, a desirable characteristic of a porous layer is to be physically robust and enhance membrane durability, but the porous layer does not necessarily need to perform gas separation.

### Example 5: Microstructure of PSF Loaded with 16 wt % C₁₈-ND

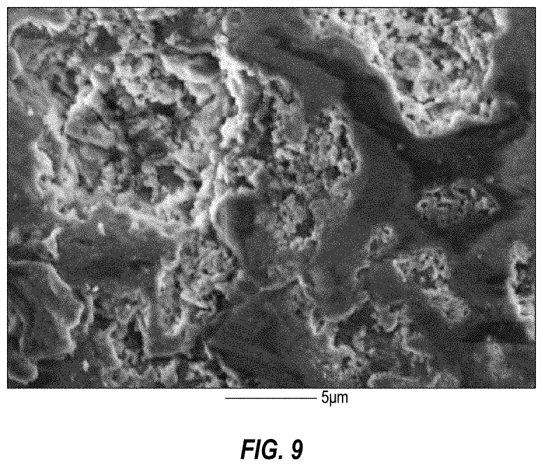

The microstructure of PSF loaded with 16 wt % C₁₈-ND was examined. A mixed matric membrane including PSF loaded with 16 wt % C₁₈-ND was formed, freeze fractured, and then examined using scanning electron microscopy (SEM). FIG. 9 shows the SEM results. As shown in FIG. 9, the PSF loaded with 16 wt % C₁₈-ND exhibited regions of microporosity imparted by the C₁₈-NDs, as well as other regions substantially free of microporosity.

### Example 6: Microstructure of Phase Inverted PSF Loaded with 2 wt % COOH-ND

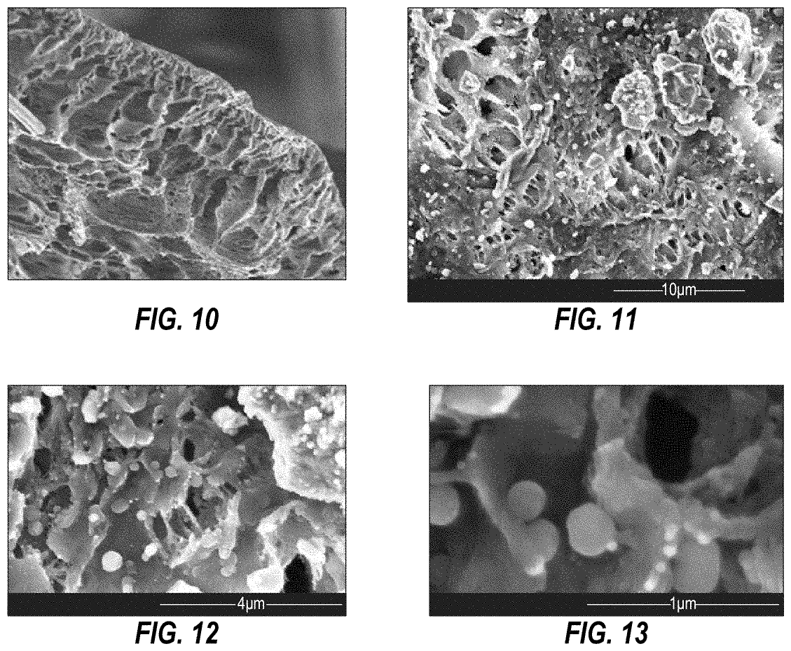

The microstructure of phase inverted PSF loaded with 2 wt % COOH-ND was examined. A mixed matric membrane including phase inverted PSF loaded with 2 wt % COOH-ND were formed, freeze fractured, and then examined using SEM. FIGS. 10 through 13 show the SEM results, wherein the magnification for the SEM image of FIG. 10 is less than the magnification for the SEM image of FIG. 11, the magnification for the SEM image of FIG. 11 is less than the magnification for the SEM image of FIG. 12, and the magnification for the SEM image of FIG. 12 is less than the magnification for the SEM image of FIG. 13. The SEM image of FIG. 10 shows the presence of pores within the phase inverted PSF loaded with 2 wt % COOH-ND. The SEM images of FIGS. 11 through 13 show, with increasing detail, the presence of COOH-NDs within the pores of the phase inverted PSF loaded with 2 wt % COOH-ND.

### Example 7: Microstructure of Phase Inverted PSF Loaded with 2 wt % C₁₈-ND

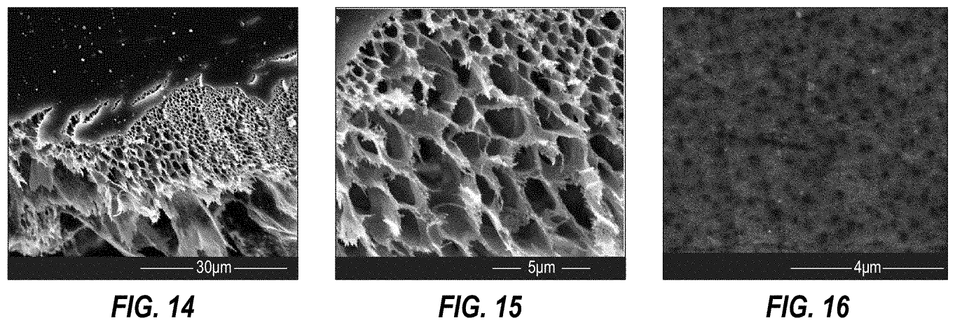

The microstructure of phase inverted PSF loaded with 2 wt % C₁₈-ND was examined using SEM. FIGS. 14 through 16 show the SEM results, wherein FIGS. 14 and 15 show different magnifications of a cross-section (facilitated by freeze fracturing) of a mixed matric membrane including the phase inverted PSF loaded with 2 wt % C₁₈-ND, and FIG. 16 shows an upper surface of the mixed matric membrane. The magnification for the SEM image of FIG. 14 is less than the magnification for the SEM image of FIG. 15. As shown in FIG. 14, the phase inverted PSF loaded with 2 wt % C₁₈-ND exhibited significant porosity, and a relatively smooth upper surface. The white spots on the upper surface are presumed to be dust contamination particles. FIG. 15 shows the cross-section of the mixed matric membrane in more detail. As shown in FIG. 15, the phase inverted PSF loaded with 2 wt % C₁₈-ND exhibited a significant degree of uniformity. In FIG. 16, the relatively lighter and darker regions are believed to correspond to small surface pores, which suggest that the phase inversion process can create a fine pore structure onto which a selective layer can be applied. The sizes of these surface pores are estimated to be within a range of from about 0.5 μm to about 1 μm in diameter, which is substantially smaller than the pore diameters of the bulk of the phase inverted PSF loaded with 2 wt % C₁₈-ND.

### Example 8: Thermal Gravimetric Analysis of Phase Inverted PSF Loaded with 2 wt % COOH-ND

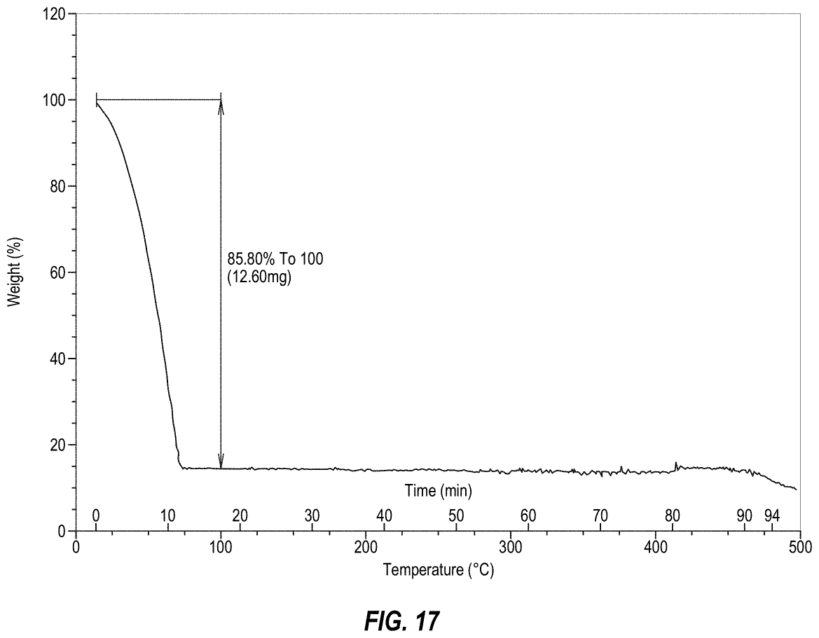

Phase inverted PSF Loaded with 2 wt % COOH-ND was subjected to thermogravimetric analysis (TGA) to determine if phase inversion effectively removed the solvent, NMP, that was employed to form the phase inverted PSF loaded with 2 wt % COOH-ND. FIG. 17 is a graph showing the results of the TGA. As shown in FIG. 17, there was a significant loss of mass below 100° C., which is attributed to water. Above 100° C. no significant loss of mass was observed until after 400° C., suggesting that the NMP was effectively removed by phase inversion.

### Example 9: Thermomechanical Analysis of PSF Loaded with C₁₈-ND

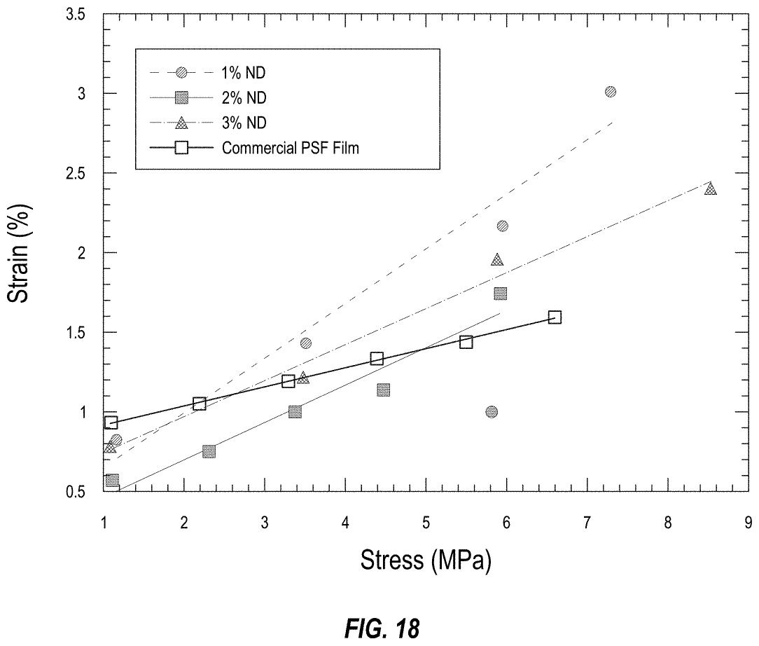

Mixed matrix membranes (approximately 13 millimeters (mm)×3 mm×0.030 mm in size) individually including PSF loaded with C₁₈-ND were individually subjected to thermomechanical analysis. A first mixed matrix membrane included PSF loaded with 1 wt % C₁₈-ND, a second mixed matrix membrane included PSF loaded with 2 wt % C₁₈-ND, and a third mixed matrix membrane included PSF loaded with 3 wt % C₁₈-ND. A PSF film free of C₁₈-ND was also subjected to thermomechanical analysis for comparison. Each mixed matrix membrane and the PSF film were placed in a fixture of a thermomechanical analyzer (TMA) (TA Instruments Q400), the temperature was initially equilibrated at −10° C., and then the temperature was ramped at 5° C./min to 150° C. The mixed matrix membranes and the PSF film were then cooled at 10° C./min to −10° C. The magnitude of a mixed matrix membrane's elongation was then measured from the upward ramp data between 20° C. and 120° C. at each stress level. FIG. 18 is a graph showing the results of the thermomechanical analysis. As shown in FIG. 18, the mixed matrix membranes were found to elongate greater in response to increasing stress. For the stress levels depicted in FIG. 18, a fairly linear correlation was observed, where the slope was calculated to be 0.120% elongation/MPa for the PSF film. Although similar linear results were obtained for all three (3) mixed matrix membranes and the PSF film, the slope associated with each material differed slightly. Loading with 1 wt % C₁₈-ND showed an increased amount of elongation, with a slope of 0.344%/MPa, suggesting some plasticization of the PSF. At loading with 2 wt % C₁₈-ND, the slope decreased to 0.234%/MPa. The slope then dropped again to 0.227%/MPa at loading with 3 wt % C₁₈-ND. Clearly, plasticization that may be imparted by the C₁₈-ND at 1 wt % loading was not additive.

### Example 10: Isothermal Stress-Strain Analysis for PSF Loaded with C₁₈-ND

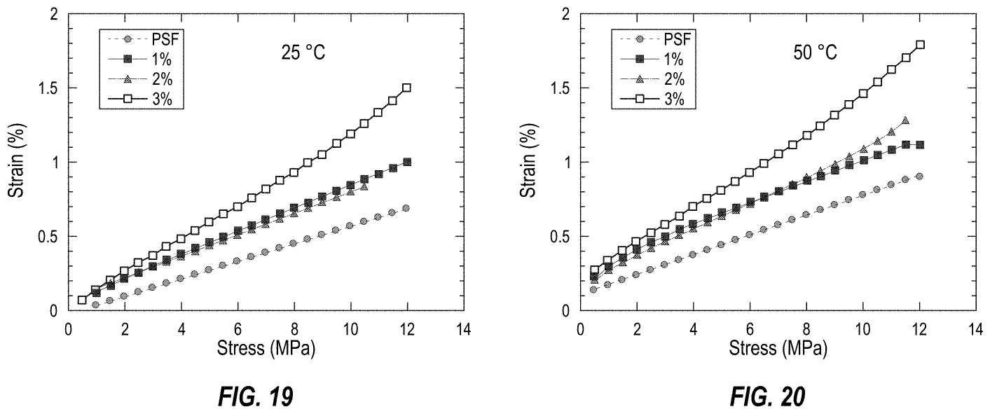

Mixed matrix membranes individually including PSF loaded with C₁₈-ND were individually subjected to isothermal stress-strain analysis to evaluate the impact of C₁₈-ND in the stress/strain relationship a function of temperature and loading. The temperatures employed in the analysis were 25° C., 50° C., 75° C., and 100° C. For each temperature, a first mixed matrix membrane included PSF loaded with 1 wt % C₁₈-ND, a second mixed matrix membrane included PSF loaded with 2 wt % C₁₈-ND, a third mixed matrix membrane included PSF loaded with 3 wt % C₁₈-ND, and a PSF film free of C₁₈-ND were analyzed. FIGS. 19 through 22 are graphs showing the results of the isothermal stress-strain analysis at 25° C., 50° C., 75° C., and 100° C., respectively. As shown in FIGS. 19 through 22, PSF exhibited linear behavior at each temperature.

At 25° C. (FIG. 19), mixed matrix membranes including 1 wt % C₁₈-ND and 2 wt % C₁₈-ND gave data similar to what was observed for pure PSF, but with a slight increase in the strain with the addition of the C₁₈-ND, which was consistent with temperature ramp experiments. Increasing the loading to 3 wt % C₁₈-ND showed a dramatic increase in strain with some non-linearity observed in stress levels. Without begin bound to a particular theory, this observation may suggest increased plasticization due to intimate interactions between the C₁₈-ND and polymer chains or a disruption in the film caused by variable C₁₈-ND depositions that weaken the tensile strength of the mixed matrix membrane.

At 50° C. (FIG. 20), the trend was similar to that at 25° C. (FIG. 19), with the C₁₈-ND influencing the strain response of the mixed matrix membranes to stress. The mixed matrix membranes including 1 wt % C₁₈-ND and 2 wt % C₁₈-ND yield similar results, and the mixed matrix membrane including 3 wt % C₁₈-ND showed a significant increase in elongation as a function of applied stress.

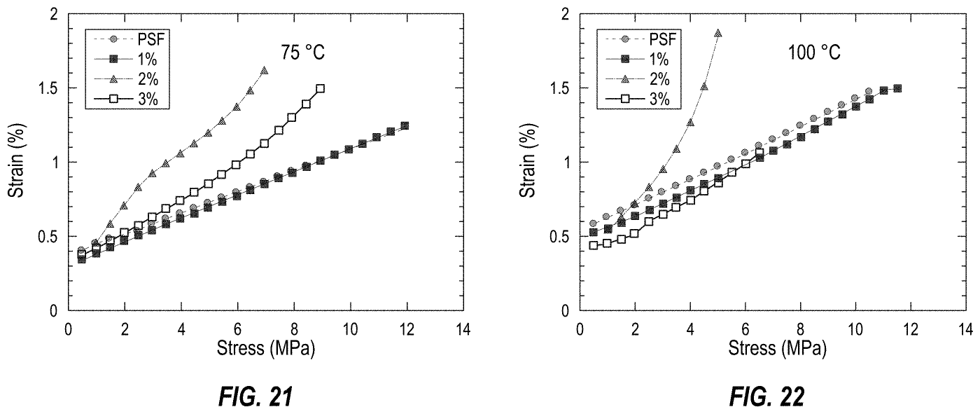

At 75° C. (FIG. 21), there were significant behavior differences as compared to those at 25° C. (FIG. 19) and 25° C. (FIG. 19). Two general observations were made. First, data the PSF film and the first mixed matrix membrane including PSF loaded with 1 wt % C₁₈-ND coalesced. Second, the second mixed matrix membrane including PSF loaded with 2 wt % C₁₈-ND yielded data suggesting that its response to stress was greater that for the third mixed matrix membrane including PSF loaded with 3 wt % C₁₈-ND. The results indicate that C₁₈-ND content in the mixed matrix membrane can alter the mechanical behaviors of PSF, which suggests disruption of polymer chain packing and intimate interactions between PSF and the C₁₈-ND.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the following appended claims and their legal equivalent. For example, elements and features disclosed in relation to one embodiment may be combined with elements and features disclosed in relation to other embodiments of the disclosure.

What is claimed is:

1. A mixed matrix membrane, comprising:
a support structure comprising:
a glassy polymer matrix; and
nanodiamond particles dispersed within the glassy polymer matrix.

2. The mixed matrix membrane of claim 1, wherein the glassy polymer matrix of the support structure comprises polysulfone (PSF).

3. The mixed matrix membrane of claim 1, wherein the glassy polymer matrix of the support structure comprises a blend of polysulfone (PSF) and at least one additional polymer.

4. The mixed matrix membrane of claim 3, wherein the at least one additional polymer comprises polyphenylene oxide (PPO).

5. The mixed matrix membrane of claim 1, wherein the nanodiamond particles of the support structure comprise functionalized nanodiamond particles.

6. The mixed matrix membrane of claim 5, wherein the functionalized nanodiamond particles are functionalized with one or more of carboxyl groups, alkyl ester groups, and perfluoro-ester groups.

7. The mixed matrix membrane of claim 5, wherein the functionalized nanodiamond particles are functionalized with one or more alkyl ester groups individually including greater than or equal to 3 carbon atoms and less than or equal to 20 carbon atoms.

8. The mixed matrix membrane of claim 7, wherein the one or more alkyl groups comprise C₁₈ alkyl groups.

9. The mixed matrix membrane of claim 1, wherein the nanodiamond particles of the support structure each individually have a particle size within a range of from about 4 nanometers to about 6 nanometers.

10. The mixed matrix membrane of claim 1, wherein some of the nanodiamond particles of the support structure are grouped together in clusters individually having a size within a range of from about 20 nanometers to about 500 nanometers.

11. The mixed matrix membrane of claim 1, wherein the support structure comprises from about 1 weight percent of the nanodiamond particles to about 25 weight percent of the nanodiamond particles.

12. The mixed matrix membrane of claim 1, wherein the support structure further comprises pores substantially free of solvents employed to form the support structure therein.

13. The mixed matrix membrane of claim 12, where the pores have micro-sized cross-sectional dimensions.

14. The mixed matrix membrane of claim 1, further comprising a selective structure over the support structure, the selective structure comprising a material selectively permeable to oxygen gas.

15. The mixed matrix membrane of claim 14, wherein the selective structure comprises one or more of polysulfone (PSF) and polyphenylene oxide (PPO).

16. The mixed matrix membrane of claim 15, wherein the selective structure further comprises additional nanodiamond particles, a weight percentage of the additional nanodiamond particles within the selective structure less than a weight percentage of the nanodiamond particles within the support structure.

17. The mixed matrix membrane of claim 14, further comprising a gutter structure in physical contact with one of more of the support structure and the selective structure.

18. A method of forming a mixed matrix membrane, comprising forming a support structure comprising a glassy polymer matrix and nanodiamond particles dispersed within the glassy polymer matrix.

19. The method of claim 18, wherein forming a support structure comprises:
combining at least one glassy polymer, nanodiamond particles, and at least one solvent formulated to dissolve the at least one glassy polymer to form a mixture;
forming a coating of the mixture over a mold structure; and
selectively removing the at least one solvent from the coating of the mixture to form the support structure.

20. The method of claim 19, wherein:
combining at least one glassy polymer, nanodiamond particles, and at least one solvent comprises selecting the at least one solvent to be soluble in water; and
selectively removing the at least one solvent from the coating of the mixture comprises treating the coating of the mixture with water to solubilize and substantially completely remove the at least one solvent.

21. The method of claim 20, wherein:
combining at least one glassy polymer, nanodiamond particles, and at least one solvent comprises selecting the at least one solvent to have a boiling point less than or equal to about 70° C.; and
selectively removing the at least one solvent from the coating of the mixture comprises heating the coating of the mixture to a temperature greater than or equal to the boiling boil of the at least one solvent to substantially completely remove the at least one solvent.

22. The method of claim 19, wherein combining at least one glassy polymer, nanoparticles, and at least one solvent comprises combining polysulfone (PSF), the nanodiamond particles, and one or more of N-methylpyrrolidone (NMP), N,N-dimethylacetamide (DMAc), N,N-dimethylformamide (DMF) and dimethylsulfoxide (DMSO).

23. The method of claim 19, wherein combining at least one glassy polymer, nanoparticles, and at least one solvent comprises combining polysulfone (PSF), the nanodiamond particles, and one or more of tetrahydrofuran (THF) and chloroform.

24. A gas separation membrane apparatus, comprising:
a housing structure; and
a mixed matrix membrane contained within the housing structure and comprising:
a support structure comprising:
a glassy polymer matrix; and
nanodiamond particles dispersed within the glassy polymer matrix; and
a selective structure coupled to the support structure and comprising at least one material selectively permeable to oxygen gas.

25. The gas separation membrane apparatus of claim 24, wherein the mixed matrix membrane exhibits one or more of a flat sheet shape, a hollow fiber shape, a tubular shape, and a spiraled shape.

26. The gas separation membrane apparatus of claim 24, wherein the glassy polymer matrix of the support structure comprises polysulfone (PSF).

27. The gas separation membrane apparatus of claim 24, wherein the nanodiamond particles of the support structure are functionalized with alkyl groups individually having between 3 carbon atoms and 20 carbon atoms.

28. The gas separation membrane apparatus of claim 24, wherein the selective structure comprises additional glassy polymer.

29. A gaseous fluid treatment system, comprising:
a gaseous fluid source configured to produce a gaseous fluid stream comprising oxygen gas and one or more other materials; and
at least one gas separation membrane apparatus downstream of the gaseous fluid source, the at least one gas separation membrane apparatus comprising:
a housing structure; and
a mixed matrix membrane positioned between a first region and a second region of an internal chamber of the housing structure, the mixed matrix membrane comprising:
a glassy polymer matrix comprising polysulfone; and
functionalized nanodiamond particles dispersed within the glassy polymer matrix.

30. The gaseous fluid treatment system of claim 29, wherein the at least one gas separation membrane apparatus comprises at least two gas separation membrane apparatuses in series with one another.
